(19) United States
(12) Patent Application Publication
(10) Pub. No.: US 2023/0323633 A1
(43) Pub. Date: Oct. 12, 2023

(54) WORK MACHINE

(71) Applicant: Liebherr-Werk Bischofshofen GmbH, Bischofshofen (AT)

(72) Inventors: Marco EDER, Zell am See (AT); Dominik ECKER, Salzburg (AT); Rupert GAPPMAIER, Altenmarkt (AT); Christoph KIEGERL, Werfenweng (AT); Hans KNAPP, Bischofshofen (AT); Leke UKIMERAJ, Hallein (AT)

(21) Appl. No.: 18/107,753

(22) Filed: Feb. 9, 2023

(30) Foreign Application Priority Data
Apr. 6, 2022 (DE) 10 2022 108 239.3

(51) Int. Cl. E02F 9/20

(52) U.S. Cl. CPC E02F 9/207; E02F 9/2091

(57) ABSTRACT

The present invention relates to a work machine having a fuel cell drive comprising a fuel cell and determination means for determining the load demand of the fuel cell, wherein the work machine has a plurality of electrical consumers that are directly or indirectly connected to the fuel cell for the purpose of obtaining electrical energy, wherein the determination means are configured such that the power requirements of at least two of the electrical consumers enter into the determination of the load demand of the fuel cell.

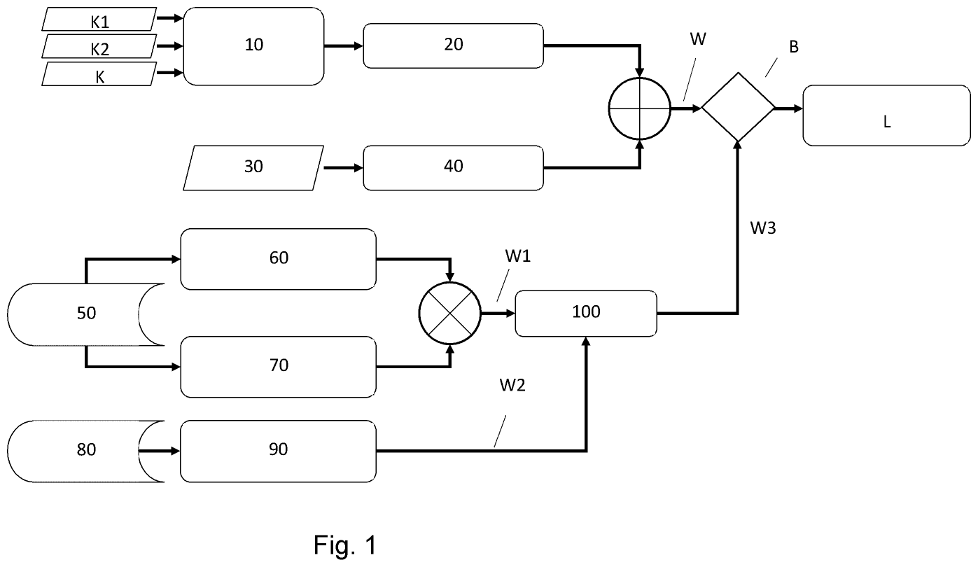

### BACKGROUND OF THE INVENTION

The present invention relates to a work machine, preferably a mobile work machine and in particular a wheeled loader and a telescopic loader, a bulldozer having wheeled and crawler chassis, articulated joint dump trucks, and earthmovers and crawler mounted loaders, having a fuel cell drive comprising a fuel cell and determination means for determining the load demand of the fuel cell, wherein the work machine has a plurality of electric consumers that are directly or indirectly connected to the fuel cell for the purpose of obtaining electrical energy.

It is known from the prior art to design passenger cars with a fuel cell drive. In this respect, hydrogen that reacts with oxygen in a chemical process is supplied to a fuel cell. The energy stored in the hydrogen is released as electrical energy here that serves to drive of an electric motor and/or to charge a battery. With passenger cars that typically only have one main drive, the load demand of the fuel cell is typically oriented on the desired demand, i.e. on the gas pedal position of the driver.

The load demand is the power value at which the fuel cell should be operated.

To extend the service life of the fuel cell, a restriction of the power dynamics and of the shutdown procedures at the fuel cell and an associated relocation of the consumer power to the battery may be expedient. If, in contrast, the best efficiency should be desired of the system, the power loss at the fuel cell and the battery has to be reduced to a minimum and the operating strategy has to be adapted.

With work machines such as wheeled loaders and other machines for earth moving and material transfer, this procedure plays a subordinate role if they have a plurality of main drives such as electric motors at the individual axles or at the individual wheels since the main drives have power requirements that are independent of one another.

### SUMMARY OF THE INVENTION

It is the underlying object of the present invention to further develop a work machine of the initially named kind such that a determination of the load demand of the fuel cell that is as precise as possible is possible.

This object is achieved by a work machine having the features herein.

Provision is accordingly made that the determination means for determining the load demand of the fuel cell are configured such that the power requirements of at least two of the electrical consumers enter into the determination of the load demand of the fuel cell. The electrical consumers are preferably main drives of the work machine, i.e. those drives that serve the propulsion of the work machine, to move the attachment, and to steer the machine.

The plurality of main drives preferably each have individua power requirements so that a corresponding regulation or control of the fuel cell load demand is advantageous.

In an aspect of the invention, first detection means are present that are configured to detect one or more pieces of machine data that have an influence on the fuel cell and/or on a battery electrically connected to the fuel cell, wherein the determination means are configured to allow the machine data to enter into the load demand of the fuel cell.

The machine data can be those data that have an influence on the service life, aging, degree of efficiency, or on the efficiency of the fuel cell and/or of the battery.

It is pointed out here that the term “fuel cell” within the framework of the present invention can mean both the fuel cell per se and a combination of the fuel cell with a battery that is fed by the fuel cell.

Within the framework of the present invention, the term “fuel cell” can alternatively or in addition to the battery and/or the fuel cell also comprise one or more components or units, preferably all the components and units, required for the operation of a fuel cell stack and a fuel cell system such as the process air production and humidification and other system elements and a voltage boost converter (DC-DC converter) that boosts the power dependent variable output voltage of the stack to the level of the battery voltage.

In work machines in accordance with the present invention, the hydraulic drives can also adopt the function of main drives.

The method of determining the load demand can be operated on a vehicle control unit and can thus be outsourced and carried out independently of standalone component control units of the fuel cell system and of the voltage boost converter (DC-DC converter) that receive the signal of the load demand from the vehicle control unit.

The work machine is formed with such a vehicle control unit in an embodiment.

Provision is made in an embodiment of the invention that filter means are present that are configured to filter the power demand of the at least two electrical consumers over time. This means that the power demand of the consumers is determined and a check is made whether they can be operated simultaneously or offset in time, which has an influence on the load request of the fuel cell.

Two detection means can furthermore be provided that are configured to detect historical data of the work machine, with the determination means being configured to allow the historical data to enter into the load demand of the fuel cell.

These past data, i.e. data previous in time, can, for example, comprise the historical power requirements of the work machine or of one or more consumers of the work machine.

It is conceivable that the second detection means are configured to prepare forecast data, i.e. a projection for the power requirements, from the historical data and the determination means are configured to allow the forecast data to enter into the determination of the load demand of the fuel cell.

Provision can furthermore be made that the determination means are configured to process the data supplied to them in a cascaded manner.

At least two of the consumers are preferably main drives of the work machine.

Alternatively or additionally, the consumer or consumers can be individual consumers that are not main drives of the work machine. Smaller hydraulic drives, means for heating and/or cooling, fans, etc. can be named as individual consumers by way of example.

The work machine can have a vehicle control unit that has one or more of the aforesaid components (determination means, filter means, detection means) and that is thus outsourced and independent of standalone component control units of the fuel cell system and of the voltage boost converter (DC-DC converter).

The present invention furthermore relates to a method of determining the load demand of a fuel cell of a work machine, wherein the work machine has a plurality of electrical consumers that are directly or indirectly connected to the fuel cell for the purpose of obtaining electrical energy, with the power requirements of at least two of the electrical consumers entering into the determination of the load demand. They are preferably two or more than two main drives of the preferably mobile work machine.

Provision is preferably made that data herein enter into the determination of the load demand. The subject matter directed to the work machine is thus also an optional subject matter of the method in accordance with the invention.

Provision is made in an embodiment of the invention that the determination of the load demand takes place by a cascade-like processing of data having an influence on the load demand.

The method in accordance with the invention of determining the load demand can be operated on a vehicle control unit and can thus be outsourced and carried out independently of standalone component control units of the fuel cell system and of the voltage boost converter (DC-DC converter).

In a preferred embodiment, the invention relates to the load demand for fuel cell drives in work machines having a plurality of main drives, wherein, in addition to the power demand of preferably all of the individual main drives, different machine parameters are used to determine the load demand and are processed in a cascade control.

The main features of a preferred embodiment are:
determining the power demand in vehicles having at least two independent main drives, determining the power demand of all further individual consumers;
determining the main machine parameters;
observing historical measurement values for influence in the control;
processing the relevant values in a cascade control.

It may be sensible in the operation of the work machine to pursue different operating strategies.

It is pointed out at this point that the terms “a” and “one” do not necessarily refer to exactly one of the elements, even though this represents a possible embodiment, but can also designate a plurality of the elements. The use of the plural equally also includes the presence of the element in question in the singular and, conversely, the singular also includes a plurality of the elements in question.

It is further pointed out that every feature of the present invention can be present in combination with every other feature or with a plurality of other features of the present invention. Any desired feature combinations are thus also the subject matter of the present disclosure.

### BRIEF DESCRIPTION OF THE DRAWINGS

Further details and advantages of the invention will be explained in more detail with reference to an embodiment shown in the drawing.

The only FIGURE shows a schematic view of the control for determining the load demand of a fuel cell, not shown in the FIGURE, of a work machine.

### DESCRIPTION OF THE PREFERRED EMBODIMENTS

The work machine can, for example, be a wheeled loader or telescopic loader, an excavator having wheeled and crawler chassis, articulated joint dump trucks, and earthmovers and crawler mounted loaders, or any other earth-moving machine or construction machine.

The work machine is preferably a mobile work machine.

The determination of the load demand L of the fuel cell takes place in the determination unit B.

The power demand of all of the load consumers (component 1: K1, component 2: K2, component n: K) is determined in the first part of the control and a total power request 10 is calculated for the fuel cell with reference to the operating strategy. Influence is taken on the dynamics of the load request using the time filtering 20.

As can further be seen from the FIGURE, the tapping of main machine parameters such as the charge state of the battery and its change takes place in parallel therewith. Reference numeral 30 marks the state variables of the battery. To operate the battery in the permitted limits, a regulator 40 determines an additional power request for compensation that is added on the calculation of the power or load requirement L of the fuel cell, as can be seen from the FIGURE.

The value compensated in this manner is marked by W in the FIGURE. The value W is supplied to the determination means B.

The second part of the control influences the operating strategy. For this purpose, various machine and component data 50 that provide information on aging processes of the fuel cell and the battery are read or measured by means of the first detection means.

Reference numeral 60 marks the degree of efficiency or the efficiency of the total system of fuel cell and battery.

70 marks the service life or aging of the total system of fuel cell and battery. As can be seen from the FIGURE, these values are combined and form a first part W1 of the correction 100 of the value W that is supplied to the determination means B and that is formed on the basis of the blocks 20, 40.

Depending on the operating strategy selected, a demand value is then determined for the power that is corrected with respect to the total load requirement L of the fuel cell. The correction value is marked by W1 in the FIGURE.

The vehicle use or its conditions of use are taken into account in the third part. It is possible to recognize recurring work patterns using historical data of the machine such as using the previous power demand of the work machine 80 that have been recorded by means of the second determination means over a defined period of time. The operating strategy can be influenced and the fuel cell power can be adapted to the required power requirements at an early point due to a corresponding prediction of work patterns (cf. reference numeral 90: prediction of the power requirements of the work machine).

As soon as work patterns have been recognized and predicted, the load requirement of the fuel cell can be adapted by a further correction in the third part of the control. The correction value is marked by W2.

Both correction values W1 and W2 are combined in the correction unit 100 and a final correction value W3 that is supplied to the determination means B is determined on the basis thereof.

A correction of the value W takes place by means of the correction value W3 in the calculation means B. On the basis of these two values (W and W3), the determination means B then ultimately determine the load requirement L at which the fuel cell is actually operated.

The aforesaid chronological listing of the individual control blocks is not mandatory. Every other sequence of said steps is also covered by the invention.

Advantages of a preferred embodiment are shown in the following:

The invention preferably relates to a method of determining the power request for the operation of a fuel cell drive in a vehicle, wherein the vehicle has a plurality of electrical main drives whose individual power requirements are determined and used to determine total vehicle power requirements in a vehicle control.

It is preferably a vehicle having a plurality of electrical main drives, wherein the vehicle is a mobile work machine.

The determination of the total vehicle power requirements preferably takes place from the data of the individual drives with a corresponding time filtering.

Battery state variables such as the charge state and its change are used in the correction of the power requirement.

The efficiency chain of the components of the fuel cell electric drive, preferably of the battery, of the fuel cell, and of the DC current converter, is taken into account to correct the power request.

The aging of the components of the fuel cell electric drive, preferably of the battery and of the fuel cell, is furthermore taken into account to correct the power request.

An optimization and refining of the fuel cell power request takes place by utilizing a load prediction process that evaluates the operating history of the vehicle with the aim of reducing energy consumption and aging.

1. A work machine having a fuel cell drive comprising a fuel cell and determination means for determining the load demand of the fuel cell, wherein
the work machine has a plurality of electrical consumers directly or indirectly connected to the fuel cell for the purpose of obtaining electrical energy, and
the determination means are configured such that the power requirements of at least two of the electrical consumers enter into the determination of the load demand of the fuel cell.

2. A work machine in accordance with claim 1, wherein
first detection means are present that are configured to detect one or more pieces of machine data that have an influence on the fuel cell and/or on a battery electrically connected to the fuel cell; and
the determination means are configured to allow the machine data to enter into the load demand of the fuel cell.

3. A work machine in accordance with claim 2, wherein the machine data have an influence on the service life, aging, degree of efficiency, or on the efficiency of the fuel cell and/or of the battery.

4. A work machine in accordance with claim 1, wherein filter means are present that are configured to filter the power demand of the at least two electrical consumers over time.

5. A work machine in accordance with claim 1, wherein
second detection means are provided that are configured to detect previous data of the work machine; and
the determination means are configured to allow the historical data to enter into the load demand of the fuel cell.

6. A work machine in accordance with claim 5, wherein the historical data comprise the past power requirements of the work machine or the historical power requirements of one or more consumers of the work machine.

7. A work machine in accordance with claim 5, wherein
the second detection means are configured to prepare forecast data from the historical data; and
the determination means are configured to allow the forecast data to enter into the determination of the load demand of the fuel cell.

8. A work machine in accordance with claim 1, wherein characterized in that the determination means are configured to process these supplied data in a cascade-like manner.

9. A work machine in accordance with claim 1, wherein
at least two of the consumers are main drives of the work machine; and/or
the consumer or consumers are individual consumers that are not main drives of the work machine.

10. A work machine in accordance with claim 1, wherein a vehicle control unit is present that has one or more of the aforesaid components, is outsourced, and is independent of standalone component control units of the fuel cell and/or of the battery and/or of the fuel cell system and/or of the voltage boost converter (DC-DC converter).

11. A method of determining the load demand of a fuel cell of a work machine, wherein
the work machine has a plurality of electrical consumers that are directly or indirectly connected to the fuel cell for the purpose of obtaining electrical energy, and
the power requirements of at least two of the electrical consumers enter into the determination of the load demand of the fuel cell.

12. A method in accordance with claim 11, wherein machine data that have an influence on the fuel cell and/or on a battery electrically connected to the fuel cell enter into the determination of the load demand.

13. A method in accordance with claim 11, wherein the determination of the load demand takes place by a cascade-like processing of data having an influence on the load demand.

14. A work machine in accordance with claim 3, wherein filter means are present that are configured to filter the power demand of the at least two electrical consumers over time.

15. A work machine in accordance with claim 2, wherein filter means are present that are configured to filter the power demand of the at least two electrical consumers over time.

16. A work machine in accordance with claim 15, wherein
second detection means are provided that are configured to detect previous data of the work machine; and
the determination means are configured to allow the historical data to enter into the load demand of the fuel cell.

17. A work machine in accordance with claim 14, wherein
second detection means are provided that are configured to detect previous data of the work machine; and
the determination means are configured to allow the historical data to enter into the load demand of the fuel cell.

18. A work machine in accordance with claim 4, wherein
second detection means are provided that are configured to detect previous data of the work machine; and
the determination means are configured to allow the historical data to enter into the load demand of the fuel cell.

19. A work machine in accordance with claim 3, wherein
second detection means are provided that are configured to detect previous data of the work machine; and
the determination means are configured to allow the historical data to enter into the load demand of the fuel cell.

20. A work machine in accordance with claim 2, wherein
second detection means are provided that are configured to detect previous data of the work machine; and
the determination means are configured to allow the historical data to enter into the load demand of the fuel cell.
